(19) United States
(12) Patent Application Publication
(10) Pub. No.: US 2019/0313878 A1
(43) Pub. Date: Oct. 17, 2019

(54) WASH PUMP IMPELLER FOR A DISHWASHING APPLIANCE AND A METHOD OF ADDITIVELY MANUFACTURING THE SAME

(71) Applicant: Haier US Appliance Solutions, Inc., Wilmington, DE (US)

(72) Inventor: John Edward Dries, Louisville, KY (US)

(21) Appl. No.: 15/953,562

(22) Filed: Apr. 16, 2018

(51) Int. Cl. A47L 15/42; A47L 15/06; B33Y 10/00; B33Y 80/00; B33Y 50/02; B29C 64/393; B28B 1/00; B28B 17/00; B29C 64/153; B29C 64/124; B29C 64/118

(52) U.S. Cl. CPC A47L 15/4225; A47L 15/06; B33Y 10/00; B33Y 80/00; B33Y 50/02; B29C 64/393; B33Y 70/00; B28B 17/0081; B29C 64/153; B29C 64/124; B29C 64/118; A47L 2501/30; B28B 1/001

(57) ABSTRACT

A wash pump impeller for a dishwasher appliance and a method of forming the same using an additive manufacturing process are provided. The wash pump impeller includes a hub and a plurality of vanes integrally formed with the hub and extending at an extension angle of less than 60 degrees relative to a flow surface of the hub and the vanes may be curved in three dimensions. The wash pump impeller is formed by establishing a three-dimensional model of the wash pump impeller, converting that model into slices defining cross-sectional layers of the wash pump impeller, and successively forming those layers using an additive manufacturing process.

### FIELD OF THE INVENTION

The present disclosure relates generally to dishwasher appliances, and more particularly to additively manufactured wash pump impellers for dishwasher appliances.

### BACKGROUND OF THE INVENTION

Dishwasher appliances generally include a tub that defines a wash chamber. Rack assemblies can be mounted within the wash chamber of the tub for receipt of articles for washing. Wash fluid (e.g., various combinations of water and detergent along with optional additives) may be introduced into the tub where it collects in a sump space at the bottom of the wash chamber. During wash and rinse cycles, a pump may be used to circulate wash fluid to spray assemblies within the wash chamber that can apply or direct wash fluid towards articles disposed within the rack assemblies in order to clean such articles. During a drain cycle, a pump may periodically discharge soiled wash fluid that collects in the sump space and the process may be repeated.

Conventional dishwasher appliances include injection molded or machined wash pump impellers for urging the flow of wash fluid onto articles for cleaning. Notably, manufacturing limitations associated with these manufacturing processes have historically resulted in inefficient wash pump impellers. More specifically, there are frequently geometrical limitations to the shapes of the impellers, e.g., in order to permit the withdrawal of sliding elements of an injection molding machine. Similarly, machined impellers typically must be designed to permit a machining tool to access all surfaces of the impeller for removing material. Specifically, conventional wash pump impellers are radial-type impellers with two-dimensional vanes.

Notably, conventional wash pump impellers frequently result in various performance limitations of the dishwashing appliance. Specifically, inefficient wash impellers will generally require larger, more expensive motors to drive the impeller and achieve the desired pressure head. In addition to increased part and energy usage costs, larger motors and impellers result in increased torque pulsations and noise.

Accordingly, a dishwasher appliance having features for improved efficiency, lower costs, and reduced noise would be useful. More specifically, a wash pump impeller for a dishwasher appliance that has a high hydraulic efficiency resulting in a quiet, energy efficient, and economical pump assembly would be particularly beneficial.

### BRIEF DESCRIPTION OF THE INVENTION

Aspects and advantages of the invention will be set forth in part in the following description, may be apparent from the description, or may be learned through practice of the invention.

In accordance with one exemplary embodiment of the present disclosure, a dishwasher appliance is provided including a wash tub defining a wash chamber for receipt of articles for washing and a sump for collecting wash fluid. A wash pump impeller is in fluid communication with the wash fluid in the sump and is configured for urging a flow of wash fluid into the wash chamber for cleaning articles. The wash pump impeller includes a hub defining a flow surface, an axial direction, a radial direction, and a circumferential direction. A plurality of vanes are integrally formed with the hub, the vanes extending from the hub at an extension angle relative to the flow surface of the hub, the extension angle being less than 60 degrees.

In accordance with another exemplary embodiment of the present disclosure, a method for forming a wash pump impeller for a dishwasher appliance is provided. The method includes establishing three-dimensional information of the wash pump impeller and converting the three-dimensional information of the wash pump impeller into a plurality of slices, each slice of the plurality of slices defining a respective cross-sectional layer of the wash pump impeller. The method further includes successively forming each cross-sectional layer of the wash pump impeller with an additive manufacturing process.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an exemplary embodiment of a dishwashing appliance of the present disclosure with a door in a partially open position.

FIG. 2 provides a side, cross sectional view of the exemplary dishwashing appliance of FIG. 1.

FIG. 3 provides a perspective view of certain components of a fluid circulation assembly according to an example embodiment of the present subject matter.

FIG. 4 provides a side, cross sectional view of the exemplary fluid circulation assembly of FIG. 3 according to an example embodiment of the present subject matter.

FIG. 5 provides a perspective view of a wash pump impeller of the exemplary fluid circulation assembly of FIG. 3 according to an example embodiment of the present subject matter.

FIG. 6 provides a top view of the exemplary wash pump impeller of FIG. 5 according to an example embodiment of the present subject matter.

FIG. 7 provides a side view of the exemplary wash pump impeller of FIG. 5 according to an example embodiment of the present subject matter.

FIG. 8 provides a cross sectional side view of the exemplary wash pump impeller of FIG. 5 according to an example embodiment of the present subject matter.

FIG. 9 is a schematic representation of the projections of a hub and vanes of the exemplary wash pump impeller of FIG. 5 into a radial plane.

FIG. 10 is a method of manufacturing the exemplary wash pump impeller of FIG. 5 according to an example embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “article” may refer to, but need not be limited to dishes, pots, pans, silverware, and other cooking utensils and items that can be cleaned in a dishwashing appliance. The term “wash cycle” is intended to refer to one or more periods of time during which a dishwashing appliance operates while containing the articles to be washed and uses a detergent and water, preferably with agitation, to e.g., remove soil particles including food and other undesirable elements from the articles. The term “rinse cycle” is intended to refer to one or more periods of time during which the dishwashing appliance operates to remove residual soil, detergents, and other undesirable elements that were retained by the articles after completion of the wash cycle. The term “drain cycle” is intended to refer to one or more periods of time during which the dishwashing appliance operates to discharge soiled water from the dishwashing appliance. The term “wash fluid” refers to a liquid used for washing and/or rinsing the articles and is typically made up of water that may include other additives such as detergent or other treatments. Furthermore, as used herein, terms of approximation, such as “approximately,” “substantially,” or “about,” refer to being within a ten percent margin of error.

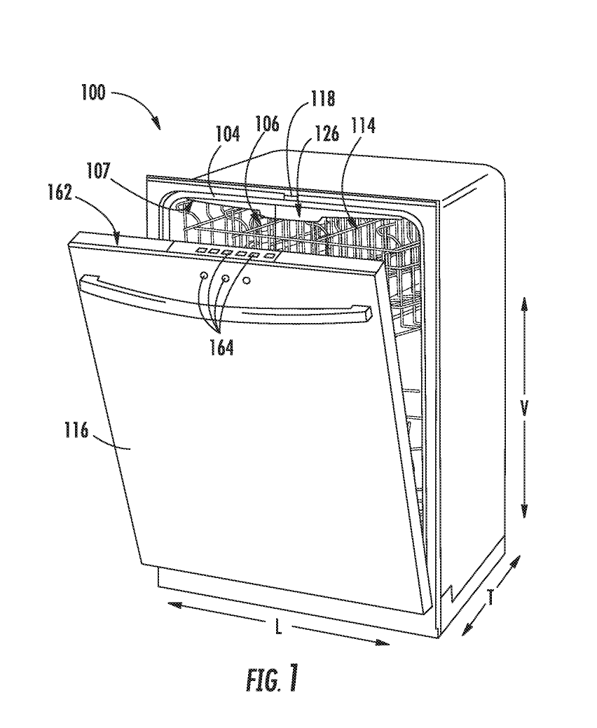

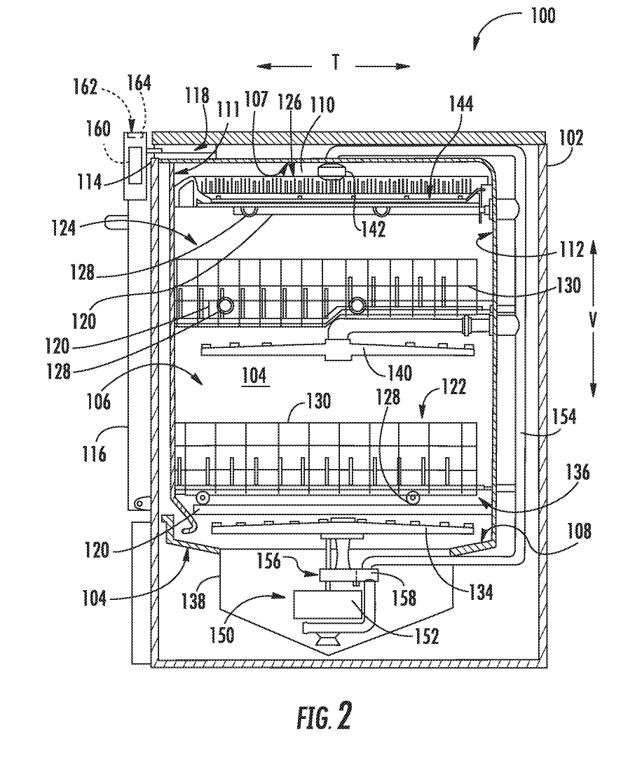

FIGS. 1 and 2 depict an exemplary domestic dishwasher or dishwashing appliance 100 that may be configured in accordance with aspects of the present disclosure. For the particular embodiment of FIGS. 1 and 2, the dishwasher 100 includes a cabinet 102 (FIG. 2) having a tub 104 therein that defines a wash chamber 106. As shown in FIG. 2, tub 104 extends between a top 107 and a bottom 108 along a vertical direction V, between a pair of side walls 110 along a lateral direction L, and between a front side 111 and a rear side 112 along a transverse direction T. Each of the vertical direction V, lateral direction L, and transverse direction T are mutually perpendicular to one another.

The tub 104 includes a front opening 114 and a door 116 hinged at its bottom for movement between a normally closed vertical position (shown in FIG. 2), wherein the wash chamber 106 is sealed shut for washing operation, and a horizontal open position for loading and unloading of articles from the dishwasher 100. According to exemplary embodiments, dishwasher 100 further includes a door closure mechanism or assembly 118 that is used to lock and unlock door 116 for accessing and sealing wash chamber 106.

As best illustrated in FIG. 2, tub side walls 110 accommodate a plurality of rack assemblies. More specifically, guide rails 120 may be mounted to side walls 110 for supporting a lower rack assembly 122, a middle rack assembly 124, and an upper rack assembly 126. As illustrated, upper rack assembly 126 is positioned at a top portion of wash chamber 106 above middle rack assembly 124, which is positioned above lower rack assembly 122 along the vertical direction V. Each rack assembly 122, 124, 126 is adapted for movement between an extended loading position (not shown) in which the rack is substantially positioned outside the wash chamber 106, and a retracted position (shown in FIGS. 1 and 2) in which the rack is located inside the wash chamber 106. This is facilitated, for example, by rollers 128 mounted onto rack assemblies 122, 124, 126, respectively. Although a guide rails 120 and rollers 128 are illustrated herein as facilitating movement of the respective rack assemblies 122, 124, 126, it should be appreciated that any suitable sliding mechanism or member may be used according to alternative embodiments.

Some or all of the rack assemblies 122, 124, 126 are fabricated into lattice structures including a plurality of wires or elongated members 130 (for clarity of illustration, not all elongated members making up rack assemblies 122, 124, 126 are shown in FIG. 2). In this regard, rack assemblies 122, 124, 126 are generally configured for supporting articles within wash chamber 106 while allowing a flow of wash fluid to reach and impinge on those articles, e.g., during a cleaning or rinsing cycle. According to another exemplary embodiment, a silverware basket (not shown) may be removably attached to a rack assembly, e.g., lower rack assembly 122, for placement of silverware, utensils, and the like, that are otherwise too small to be accommodated by rack 122.

Dishwasher 100 further includes a plurality of spray assemblies for urging a flow of water or wash fluid onto the articles placed within wash chamber 106. More specifically, as illustrated in FIG. 2, dishwasher 100 includes a lower spray arm assembly 134 disposed in a lower region 136 of wash chamber 106 and above a sump 138 so as to rotate in relatively close proximity to lower rack assembly 122. Similarly, a mid-level spray arm assembly 140 is located in an upper region of wash chamber 106 and may be located below and in close proximity to middle rack assembly 124. In this regard, mid-level spray arm assembly 140 may generally be configured for urging a flow of wash fluid up through middle rack assembly 124 and upper rack assembly 126. Additionally, an upper spray assembly 142 may be located above upper rack assembly 126 along the vertical direction V. In this manner, upper spray assembly 142 may be configured for urging and/or cascading a flow of wash fluid downward over rack assemblies 122, 124, and 126. As further illustrated in FIG. 2, upper rack assembly 126 may further define an integral spray manifold 144, which is generally configured for urging a flow of wash fluid substantially upward along the vertical direction V through upper rack assembly 126.

The various spray assemblies and manifolds described herein may be part of a fluid distribution system or fluid circulation assembly 150 for circulating water and wash fluid in the tub 104. More specifically, fluid circulation assembly 150 includes a pump 152 for circulating water and wash fluid (e.g., detergent, water, and/or rinse aid) in the tub 104. Pump 152 may be located within sump 138 or within a machinery compartment located below sump 138 of tub 104, as generally recognized in the art. Fluid circulation assembly 150 may include one or more fluid conduits or circulation piping for directing water and/or wash fluid from pump 152 to the various spray assemblies and manifolds. For example, as illustrated in FIG. 2, a primary supply conduit 154 may extend from pump 152, along rear 112 of tub 104 along the vertical direction V to supply wash fluid throughout wash chamber 106.

As illustrated, primary supply conduit 154 is used to supply wash fluid to one or more spray assemblies, e.g., to mid-level spray arm assembly 140 and upper spray assembly 142. However, it should be appreciated that according to alternative embodiments, any other suitable plumbing configuration may be used to supply wash fluid throughout the various spray manifolds and assemblies described herein. For example, according to another exemplary embodiment, primary supply conduit 154 could be used to provide wash fluid to mid-level spray arm assembly 140 and a dedicated secondary supply conduit (not shown) could be utilized to provide wash fluid to upper spray assembly 142. Other plumbing configurations may be used for providing wash fluid to the various spray devices and manifolds at any location within dishwasher appliance 100.

Each spray arm assembly 134, 140, 142, integral spray manifold 144, or other spray device may include an arrangement of discharge ports or orifices for directing wash fluid received from pump 152 onto dishes or other articles located in wash chamber 106. The arrangement of the discharge ports, also referred to as jets, apertures, or orifices, may provide a rotational force by virtue of wash fluid flowing through the discharge ports. Alternatively, spray arm assemblies 134, 140, 142 may be motor-driven, or may operate using any other suitable drive mechanism. Spray manifolds and assemblies may also be stationary. The resultant movement of the spray arm assemblies 134, 140, 142 and the spray from fixed manifolds provides coverage of dishes and other dishwasher contents with a washing spray. Other configurations of spray assemblies may be used as well. For example, dishwasher 100 may have additional spray assemblies for cleaning silverware, for scouring casserole dishes, for spraying pots and pans, for cleaning bottles, etc. One skilled in the art will appreciate that the embodiments discussed herein are used for the purpose of explanation only, and are not limitations of the present subject matter.

In operation, pump 152 draws wash fluid in from sump 138 and pumps it to a diverter assembly 156, e.g., which is positioned within sump 138 of dishwasher appliance. Diverter assembly 156 may include a diverter disk (not shown) disposed within a diverter chamber 158 for selectively distributing the wash fluid to the spray arm assemblies 134, 140, 142 and/or other spray manifolds or devices. For example, the diverter disk may have a plurality of apertures that are configured to align with one or more outlet ports (not shown) at the top of diverter chamber 158. In this manner, the diverter disk may be selectively rotated to provide wash fluid to the desired spray device.

According to an exemplary embodiment, diverter assembly 156 is configured for selectively distributing the flow of wash fluid from pump 152 to various fluid supply conduits, only some of which are illustrated in FIG. 2 for clarity. More specifically, diverter assembly 156 may include four outlet ports (not shown) for supplying wash fluid to a first conduit for rotating lower spray arm assembly 134, a second conduit for rotating mid-level spray arm assembly 140, a third conduit for spraying upper spray assembly 142, and a fourth conduit for spraying an auxiliary rack such as the silverware rack.

The dishwasher 100 is further equipped with a controller 160 to regulate operation of the dishwasher 100. The controller 160 may include one or more memory devices and one or more microprocessors, such as general or special purpose microprocessors operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 160 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

The controller 160 may be positioned in a variety of locations throughout dishwasher 100. In the illustrated embodiment, the controller 160 may be located within a control panel area 162 of door 116 as shown in FIGS. 1 and 2. In such an embodiment, input/output (“I/O”) signals may be routed between the control system and various operational components of dishwasher 100 along wiring harnesses that may be routed through the bottom of door 116. Typically, the controller 160 includes a user interface panel/controls 164 through which a user may select various operational features and modes and monitor progress of the dishwasher 100. In one embodiment, the user interface 164 may represent a general purpose I/O (“GPIO”) device or functional block. In one embodiment, the user interface 164 may include input components, such as one or more of a variety of electrical, mechanical or electro-mechanical input devices including rotary dials, push buttons, and touch pads. The user interface 164 may include a display component, such as a digital or analog display device designed to provide operational feedback to a user. The user interface 164 may be in communication with the controller 160 via one or more signal lines or shared communication busses.

It should be appreciated that the invention is not limited to any particular style, model, or configuration of dishwasher 100. The exemplary embodiment depicted in FIGS. 1 and 2 is for illustrative purposes only. For example, different locations may be provided for user interface 164, different configurations may be provided for rack assemblies 122, 124, 126, different spray arm assemblies 134, 140, 142 and spray manifold configurations may be used, and other differences may be applied while remaining within the scope of the present subject matter.

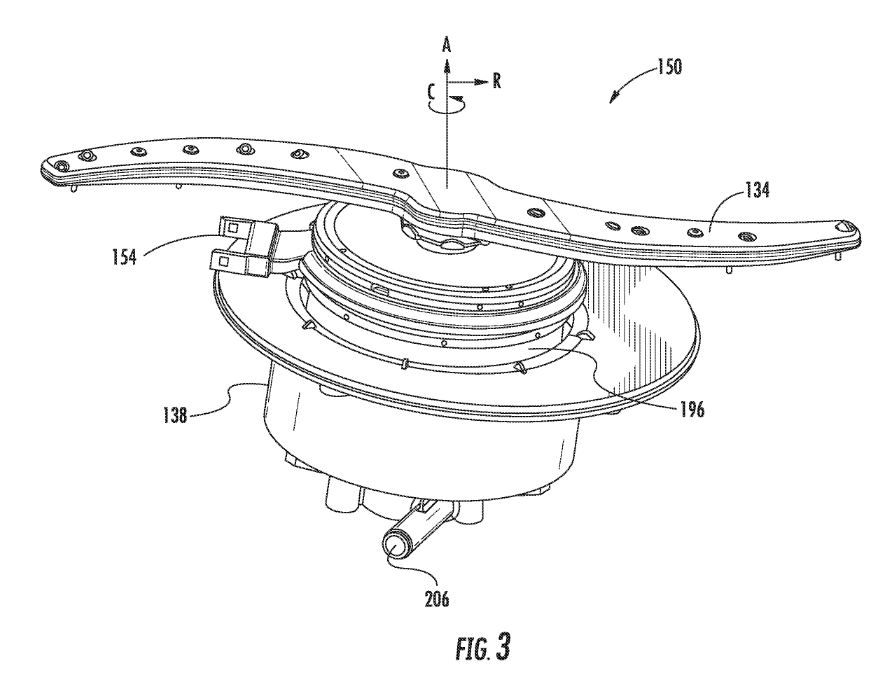

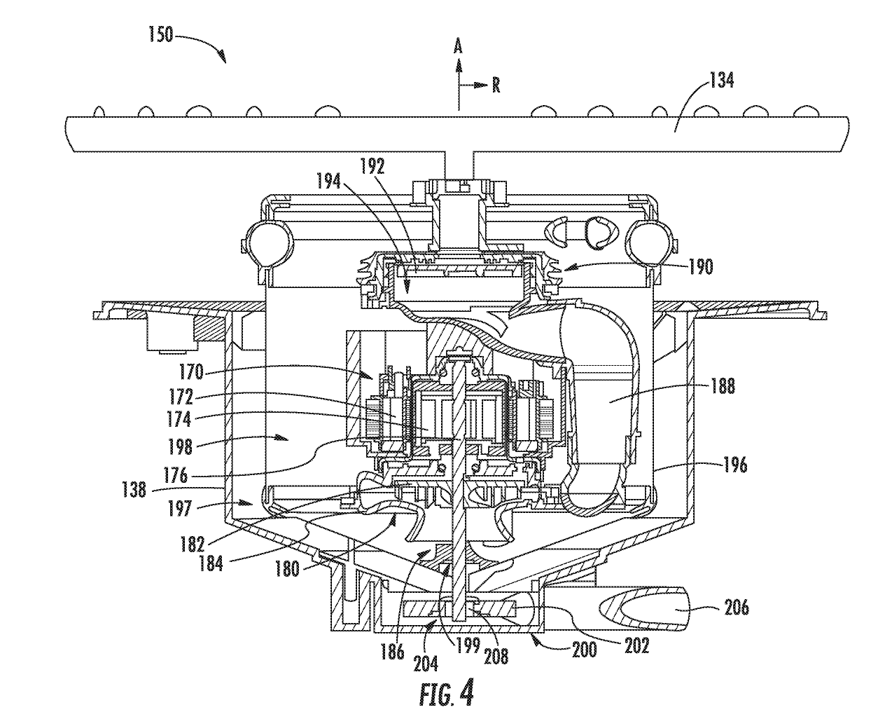

Referring now generally to FIGS. 3 and 4, fluid circulation assembly 150 will be described according to an example embodiment of the present subject matter. Fluid circulation assembly 150 may include a drive motor 170 that may be disposed within sump 138 of tub 104 and may be configured to rotate multiple components of dishwasher 100. As best shown in FIG. 4, drive motor 170 may be, for example, a brushless DC motor having a stator 172, a rotor 174, and a drive shaft 176 attached to rotor 174. A controller or control board (not shown) may control the speed of motor 170 and rotation of drive shaft 176 by selectively applying electric current to stator 172 to cause rotor 174 and drive shaft 176 to rotate. Although drive motor 170 is illustrated herein as a brushless DC motor, it should be appreciated that any suitable motor may be used while remaining within the scope of the present subject matter. For example, according to alternative embodiments, drive motor 170 may instead be a synchronous permanent magnet motor.

According to an example embodiment, drive motor 170 may be a variable speed motor. In this regard, drive motor 170 may be operated at various speeds depending on the current operating cycle of the dishwasher. For example, according to an exemplary embodiment, drive motor 170 may be configured to operate at any speed between a minimum speed, e.g., 1500 revolutions per minute (RPM), to a maximum rated speed, e.g., 4500 RPM. In this manner, use of a variable speed drive motor 170 enables efficient operation of dishwasher 100 in any operating mode. Thus, for example, the drain cycle may require a lower rotational speed than a wash cycle and/or rinse cycle. A variable speed drive motor 170 allows impeller rotation at the desired speeds while minimizing energy usage and unnecessary noise when drive motor 170 does not need to operate at full speed.

According to an exemplary embodiment, drive motor 170 and all its components may be potted. In this manner, drive motor 170 may be shock-resistant, submersible, and generally more reliable. Notably, because drive motor 170 is mounted inside wash chamber 106 and is completely submersible, no seals are required and the likelihood of leaks is reduced. In addition, because drive motor 170 is mounted in the normally unused space between lower spray arm assembly 134 and a bottom wall of sump 138, instead of beneath the sump 138, this design is inherently more compact than conventional designs.

According to an exemplary embodiment, fluid circulation assembly 150 may be vertically mounted within sump 138 of wash chamber 106. More particularly, drive motor 170 of fluid circulation assembly 150 may be mounted such that drive shaft 176 is oriented along vertical direction V of dishwasher 100. More particularly, drive shaft 176 may define an axial direction A, a radial direction R, and a circumferential direction C (FIG. 3), with the axial direction A being parallel to the vertical direction V of the dishwasher 100. As illustrated in FIG. 4, drive shaft 176 is rotatably supported by upper and lower bearings and extends out of a bottom of drive motor 170 toward a bottom of sump 138.

Referring now to FIG. 4, drive shaft 176 is configured for driving a circulation or wash pump assembly 180. Wash pump assembly 180 may generally be configured for circulating wash fluid within wash chamber 106 during wash and/or rinse cycles. More specifically, wash pump assembly 180 may include a wash pump impeller 182 disposed on drive shaft 176 within a pump housing 184. Pump housing 184 defines a pump intake 186 for drawing wash fluid into wash pump impeller 182. According to the illustrated embodiment, pump intake 186 is facing downward along the vertical direction V and is located very near the bottom of sump 138. In this manner, the amount of water required to prime and operate wash pump assembly 180 is minimized. This is particularly advantageous when running low water cycles for the purpose of water and energy savings.

Referring still to FIG. 4, pump housing 184 is in fluid communication with a supply conduit 188 through which pressurized wash fluid may be recirculated through fluid circulation assembly 150. More specifically, according to the illustrated embodiment, wash pump impeller 182 draws wash fluid in from sump 138 and pumps it through supply conduit 188 to a diverter assembly 190 (such as diverter assembly 156) which generally distributes the flow of wash fluid as desired within dishwasher 100.

As shown, diverter assembly 190 may include a diverter disc 192 disposed within a diverter chamber 194 (such as diverter chamber 158). Diverter chamber 194 is fluidly coupled to supply conduit 188, such that rotating diverter disc 192 may selectively distribute the flow of wash fluid to the spray arm assemblies 134, 140, 142, or any other fluid conduit coupled to diverter chamber 194. More particularly, diverter disc 192 may be rotatably mounted about the vertical direction V. Diverter disc 192 may have a plurality of apertures that are configured to align with a one or more outlet ports at the top of diverter chamber 194. In this manner, diverter disc 192 may be selectively rotated to provide wash fluid to spray arm assemblies 134, 140, 142 or other spray assemblies.

As illustrated in FIG. 3, fluid circulation assembly 150 further includes a filter screen or filter 196. In general, filter 196 may define an unfiltered region 197 and a filtered region 198 within sump 138. During a wash or rinse cycle, wash fluid sprayed on dishes or other articles within wash chamber 106 falls into the unfiltered region 197. Wash fluid passes through filter 196 which removes food particles, resulting in relatively clean wash fluid within the filtered region 198. As used herein, “food particles” refers to food soil, particles, sediment, or other contaminants in the wash fluid which are not intended to travel through filter 196. Thus, a food particle seal may allow water or other wash fluids to pass from the unfiltered region 197 to the filtered region 198 while preventing food particles entrained within that wash fluid from passing along with the wash fluid.

As illustrated, filter 196 is a cylindrical and conical fine mesh filter constructed from a perforated stainless steel plate. Filter 196 may include a plurality of perforated holes, e.g., approximately 15/1000 of an inch in diameter, such that wash fluid may pass through filter 196, but food particles entrained in the wash fluid do not pass through filter 196. However, according to alternative embodiments, filter 196 may be any structure suitable for filtering food particles from wash fluid passing through filter 196. For example, filter 196 may be constructed from any suitably rigid material, may be formed into any suitable shape, and may include apertures of any suitable size for capturing particulates.

According to the illustrated exemplary embodiment, filter 196 defines an aperture through which drive shaft 176 extends. Wash pump impeller 182 is coupled to drive shaft 176 above filter 196 and a drain pump assembly (e.g., as described below) is coupled to drive shaft 176 below filter 196 along the vertical direction V. Fluid circulation assembly 150 may further include an inlet guide assembly 199 which is configured for accurately locating and securing filter 196 while allowing drive shaft 176 to pass through aperture and minimizing leaks between the filtered and unfiltered regions 197, 198 of sump 138. More specifically, as best illustrated in FIG. 4, drive shaft 176 passes through a clearance bore in inlet guide assembly 199 and through filter 196 between unfiltered region 197 and filtered region 198 of sump 138. Because the clearance bore has a diameter that is larger than the diameter of drive shaft 176, inlet guide assembly 199 may further include a washer disposed within a chamber, e.g., in order to accommodate minor drive shaft wobble or misalignment while retaining a particle tight seal.

Referring again to FIG. 4, a drain pump assembly 200 according to an exemplary embodiment of the present subject matter will be described. Drain pump assembly 200 may generally be configured for periodically discharging soiled wash fluid from dishwasher 100. Drain pump assembly 200 may include a drain pump impeller 202 coupled to a bottom portion of drive shaft 176 and positioned within a drain volute 204 below filter 196. As best shown in FIG. 4, drain pump assembly 200 further includes a discharge conduit 206 that extends from and is in fluid communication with drain volute 204. As illustrated drive shaft 176 passes into drain volute 204 where it is coupled to drain pump impeller 202. During a drain cycle, drain pump impeller 202 draws soiled wash fluid into drain volute 204 and discharges it through discharge conduit 206.

Notably, drain pump impeller 202 is coupled to the bottom portion of drive shaft 176 using a one-way clutch 208. In this regard, during a wash/rinse cycle, drive motor 170 rotates in one direction, pumping filtered wash fluid using wash pump impeller 182. However, one-way clutch 208 is disengaged, so drain pump impeller 202 does not rotate at the same speed. Instead, drain pump impeller 202 may rotate at a decreased speed, e.g., due to some friction between one-way clutch 208 and drive shaft 176. According to alternative embodiments, drain pump impeller 202 may remain stationary during the wash cycle or may rotate at the same speed as wash pump impeller 182. In both cases, soil and food particles will have a tendency to collect within drain volute 204, as described herein. By contrast, during a drain cycle, drive motor 170 rotates in the opposite direction, thereby engaging one-way clutch 208 and causing drain pump impeller 202 to rotate and discharge wash fluid.

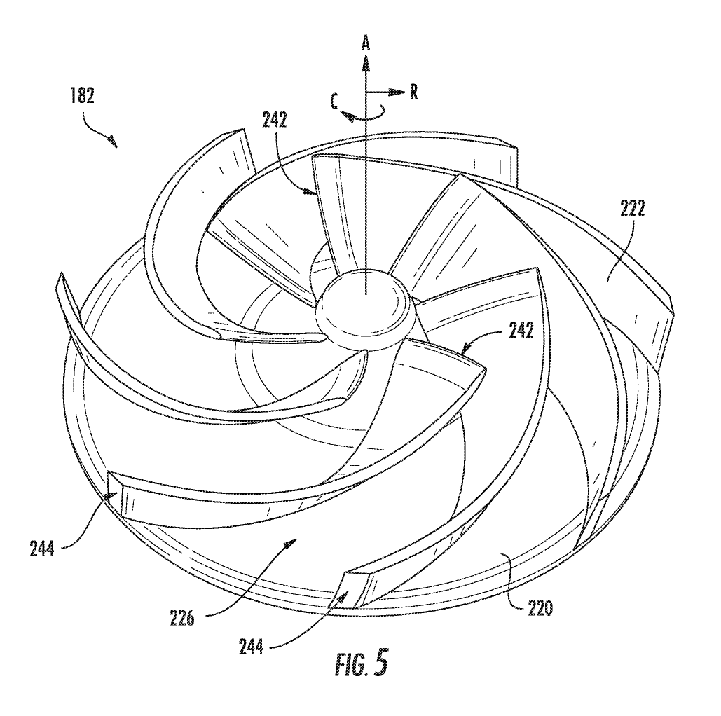

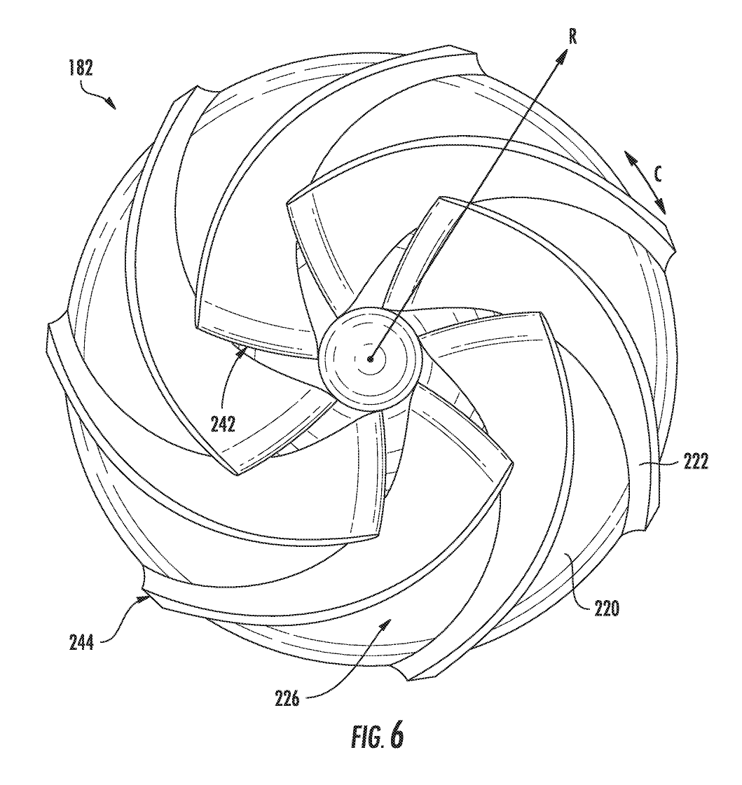

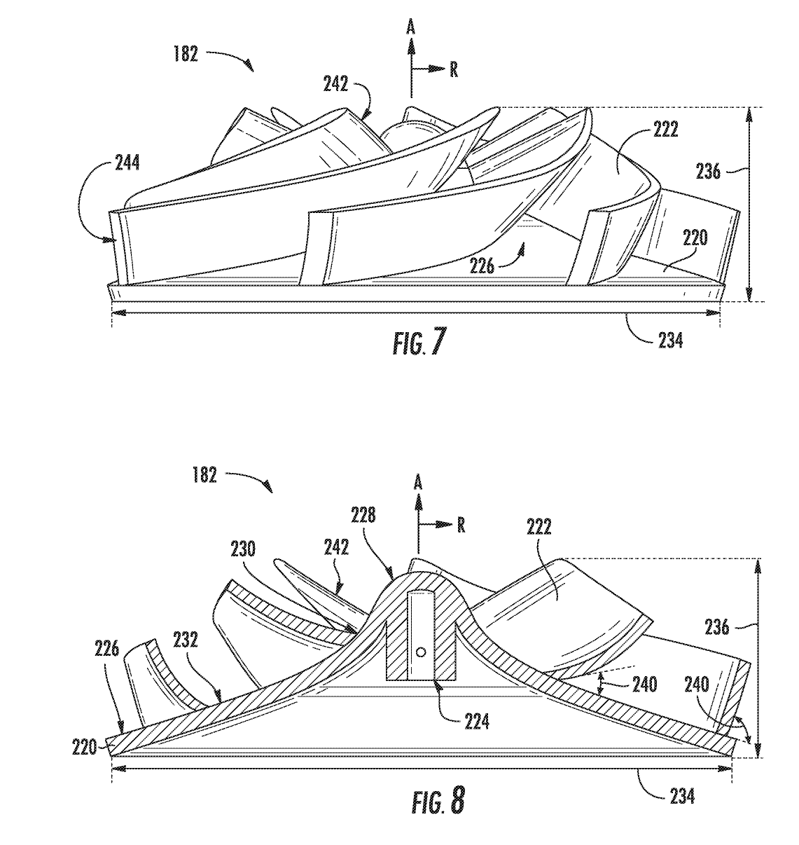

Referring now specifically to FIGS. 5 through 8, wash pump impeller 182 will be described according to an exemplary embodiment of the present subject matter. In general, wash pump impeller 182 and includes a hub 220 and a plurality of vanes 222 extending therefrom. More specifically, as explained in detail herein, hub 220 and vanes 222 of wash pump impeller 182 may be integrally formed as a single, monolithic component. In this regard, for example, wash pump impeller 182 may be formed from a single continuous piece of plastic, but may have geometries and vane designs that cannot be manufactured using conventional injection molding or machining processes.

As shown, 220 may generally define an axial direction A, a radial direction R, and a circumferential direction C that correspond to the same directions defined by drive shaft 176 when installed in wash pump assembly 180. Wash pump impeller 182, or more specifically hub 220, may define a receiving boss 224 that is configured for receiving drive shaft 176. In this regard, receiving boss 224 may be integrally formed with hub 220 and vanes 222. Moreover, receiving boss 224 may define a keyed or complementary profile for engaging drive shaft 176 to rotatably fix hub 220 to drive shaft 176. In addition, receiving boss 224 may define one or more apertures (not shown) for receiving a cotter pin, a set screw, or another suitable securing means for coupling wash pump impeller 182 to drive shaft 176.

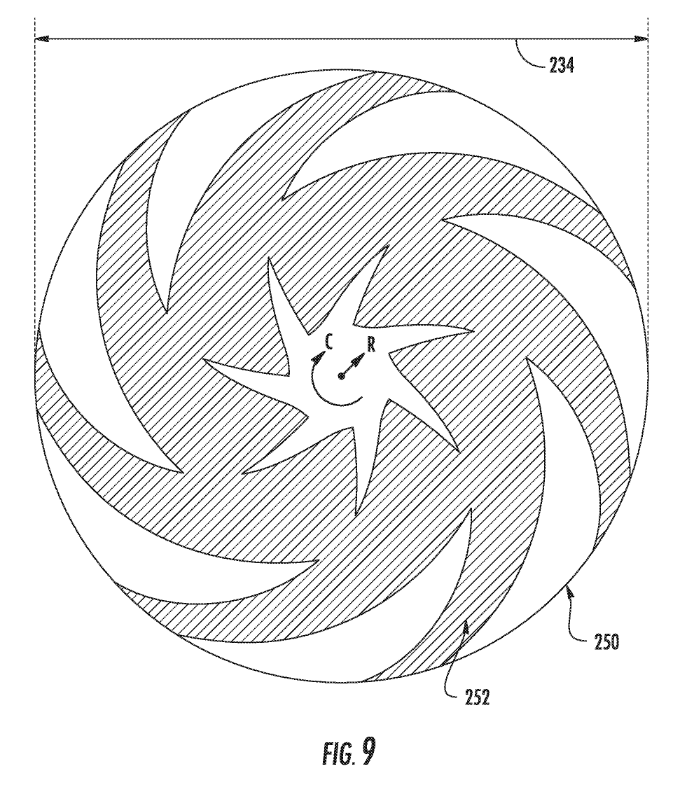

According to the illustrated embodiment, hub 220 defines a flow surface 226 that is positioned on opposite receiving boss 224. Vanes 222 extend from flow surface 226 into sump 138, such that they are exposed to wash fluid therein. In this manner, when drive motor 170 rotates drive shaft 176, wash pump impeller 182 is configured for urging a flow of wash fluid into wash chamber 106 for cleaning articles positioned therein. As best shown in FIG. 8, flow surface 226 may generally define any suitable profile for improving the flow of wash fluid through wash pump assembly 180. In this regard, for example, flow surface 226 may have a generally conical shape or parabolic profile that extends into sump 138 and is designed (e.g., using a computational fluid dynamics model) for improved pumping performance. More specifically, according to the illustrated embodiment, flow surface 226 defines at least one convex portion 228 (e.g. proximate a center of hub 220), at least one concave portion 230, and at least one straight portion 232.

In addition, according to exemplary embodiments of the present subject matter, hub 220 may have any suitable size for urging a flow of wash fluid within dishwasher appliance 100. For example, hub 220 may define a hub diameter 234 which is measured in a radial plane defined by the radial direction R (e.g., a plane defined perpendicular to the axial direction A). In addition, hub 220 may define a hub height 236 defined along the axial direction A. According to exemplary embodiments, the hub diameter 234 is less than 10 inches, less than 5 inches, or even smaller. In addition, hub height 236 may be approximately half of hub diameter 234, e.g. such as between 1 and 3 inches. It should be appreciated that these values are only exemplary and are not intended to limit the scope of the present subject matter. Thus, the contour of hub 220 shown herein could instead have any other suitable shape according to alternative embodiments.

Referring again generally to FIGS. 5 through 8, wash pump impeller 182 may include seven vanes 222 that extend from hub 220. Although the exemplary embodiment described herein has seven vanes 222, it should be appreciated that wash pump impeller 182 may include any other suitable number of vanes 222 according to alternative embodiments. In addition, it should be appreciated that vanes 222 are integrally formed with hub 220. Although exemplary vane geometries are described below according to an exemplary embodiment, it should be appreciated that aspects of the present subject matter may be used to form wash pump impellers having any suitable vane geometries.

As best shown in FIG. 8, each vane 222 extends from hub 220 at an extension angle 240 relative to flow surface 226 of hub 220. In this regard, for example, each vane 222 may define a leading edge 242 (e.g., proximate a center of hub 220) and a trailing edge 244 (e.g., proximate an outer rim of hub 220). The extension angle 240 may vary along a length of each vane 222 between leading edge 242 and trailing edge 244. Specifically, as illustrated, the extension angle 240 is smaller proximate leading edge 242 and becomes larger proximate trailing edge 244. According to an exemplary embodiment, the extension angle 240 may be less than 60 degrees, less than 50 degrees, less than 45 degrees, or even smaller. Indeed, according to one exemplary embodiment, extension angle 240 may be so small at leading edge 242 and the slope of hub 220 may be such that vane 222 extends substantially along the radial direction R.

Notably, in addition to extending at angles other than 90 degrees from hub 220, vanes 222 may generally be curved within three dimensions. More specifically, vanes may be curved within a radial plane defined perpendicular to the axial direction A, e.g., similar to conventional two-dimensional radial impellers. However, vanes 222 may also sweep backwards over and adjacent vane 222 for improved flow characteristics. Notably, as explained briefly above, vanes 222 may typically not be formed using conventional manufacturing techniques such as injection molding and machining because sliding elements of an injection molding machine must be removed or a machining tool must be able to access the back side of each vane 222, which is typically not possible for the vane geometries described herein.

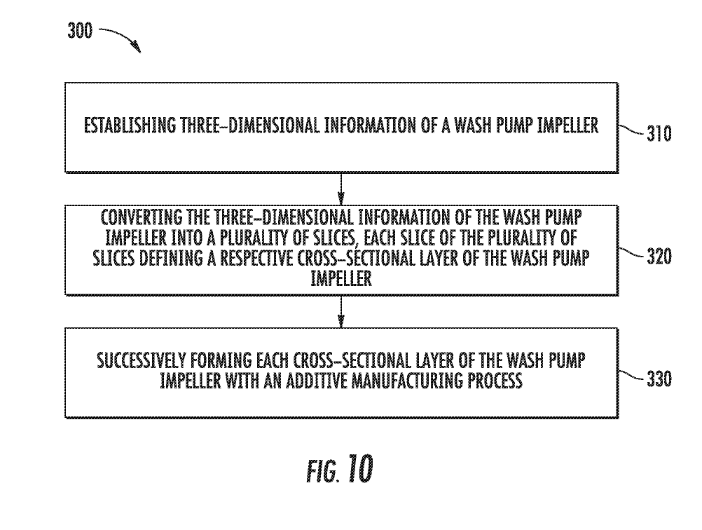

Referring now specifically to FIG. 9, a schematic view of the projections made by hub 220 and vanes 222 in a radial plane defined perpendicular to the axial direction A will be described according to an exemplary embodiment. In this regard, hub 220 may define a hub projection area 250 within the radial plane. Specifically, hub projection area 250 is equivalent to half of hub diameter 234 squared times Pi according to an exemplary embodiment. Vanes 222 also define a vane projection area 252 within the radial plane. Notably, due to the large sweeping design of vanes 222, vane projection area 252 may cover greater than 30%, greater than 50%, or greater than 70% of hub projection area 250. Notably, manufacturing such vanes 222 integrally with hub 220 is difficult or impossible using conventional techniques, particularly given the shape/sweep of vanes 222 and the very small size of hub 220.

In general, the exemplary embodiments of wash pump impeller 182 described herein may be manufactured or formed using any suitable process. However, in accordance with several aspects of the present subject matter, wash pump impeller 182 may be formed using an additive manufacturing process, such as a 3-D printing process. The use of such a process may allow wash pump impeller 182 to be formed integrally, as a single monolithic component, or as any suitable number of sub-components. In particular, the manufacturing process may allow wash pump impeller 182 to be integrally formed and include a variety of features and geometries not possible when using prior manufacturing methods. Some of these novel features are described herein.

As used herein, the terms “additively manufactured” or “additive manufacturing techniques or processes” refer generally to manufacturing processes wherein successive layers of material(s) are provided on each other to “build-up,” layer-by-layer, a three-dimensional component. The successive layers generally fuse together to form a monolithic component which may have a variety of integral sub-components. Although additive manufacturing technology is described herein as enabling fabrication of complex objects by building objects point-by-point, layer-by-layer, typically in a vertical direction, other methods of fabrication are possible and within the scope of the present subject matter. For example, although the discussion herein refers to the addition of material to form successive layers, one skilled in the art will appreciate that the methods and structures disclosed herein may be practiced with any additive manufacturing technique or manufacturing technology. For example, embodiments of the present invention may use layer-additive processes, layer-subtractive processes, or hybrid processes.

Suitable additive manufacturing techniques in accordance with the present disclosure include, for example, Fused Deposition Modeling (FDM), Selective Laser Sintering (SLS), 3D printing such as by inkjets and laserjets, Sterolithography (SLA),

Direct Selective Laser Sintering (DSLS), Electron Beam Sintering (EBS), Electron Beam Melting (EBM), Laser Engineered Net Shaping (LENS), Laser Net Shape Manufacturing (LNSM), Direct Metal Deposition (DMD), Digital Light Processing (DLP), Direct Selective Laser Melting (DSLM), Selective Laser Melting (SLM), Direct Metal Laser Melting (DMLM), and other known processes.

In addition to using a direct metal laser sintering (DMLS) or direct metal laser melting (DMLM) process where an energy source is used to selectively sinter or melt portions of a layer of powder, it should be appreciated that according to alternative embodiments, the additive manufacturing process may be a “binder jetting” process. In this regard, binder jetting involves successively depositing layers of additive powder in a similar manner as described above. However, instead of using an energy source to generate an energy beam to selectively melt or fuse the additive powders, binder jetting involves selectively depositing a liquid binding agent onto each layer of powder. The liquid binding agent may be, for example, a photo-curable polymer or another liquid bonding agent. Other suitable additive manufacturing methods and variants are intended to be within the scope of the present subject matter.

The additive manufacturing processes described herein may be used for forming components using any suitable material. For example, the material may be plastic, metal, concrete, ceramic, polymer, epoxy, photopolymer resin, or any other suitable material that may be in solid, liquid, powder, sheet material, wire, or any other suitable form. In addition, according to exemplary embodiments of the present subject matter, the additively manufactured components described herein may be formed in part, in whole, or in some combination of any or all of the materials described above, as well as with other known materials. These materials are examples of materials suitable for use in the additive manufacturing processes described herein, and may be generally referred to as “additive materials.”

In addition, one skilled in the art will appreciate that a variety of materials and methods for bonding those materials may be used and are contemplated as within the scope of the present disclosure. As used herein, references to “fusing” may refer to any suitable process for creating a bonded layer of any of the above materials. For example, if an object is made from polymer, fusing may refer to creating a thermoset bond between polymer materials. If the object is epoxy, the bond may be formed by a crosslinking process. If the material is ceramic, the bond may be formed by a sintering process. If the material is powdered metal, the bond may be formed by a melting or sintering process. One skilled in the art will appreciate that other methods of fusing materials to make a component by additive manufacturing are possible, and the presently disclosed subject matter may be practiced with those methods.

In addition, the additive manufacturing process disclosed herein allows a single component to be formed from multiple materials. Thus, the components described herein may be formed from any suitable mixtures of the above materials. For example, a component may include multiple layers, segments, or parts that are formed using different materials, processes, and/or on different additive manufacturing machines. In this manner, components may be constructed which have different materials and material properties for meeting the demands of any particular application. In addition, although the components described herein are constructed entirely by additive manufacturing processes, it should be appreciated that in alternate embodiments, all or a portion of these components may be formed via casting, machining, and/or any other suitable manufacturing process. Indeed, any suitable combination of materials and manufacturing methods may be used to form these components.

An exemplary additive manufacturing process will now be described. Additive manufacturing processes fabricate components using three-dimensional (3D) information, for example a three-dimensional computer model, of the component. Accordingly, a three-dimensional design model of the component may be defined prior to manufacturing. In this regard, a model or prototype of the component may be scanned to determine the three-dimensional information of the component. As another example, a model of the component may be constructed using a suitable computer aided design (CAD) program to define the three-dimensional design model of the component.

The design model may include 3D numeric coordinates of the entire configuration of the component including both external and internal surfaces of the component. For example, the design model may define the body, the surface, and/or internal passageways such as openings, support structures, etc. In one exemplary embodiment, the three-dimensional design model is converted into a plurality of slices or segments, e.g., along a central (e.g., vertical) axis of the component or any other suitable axis. Each slice may define a thin cross section of the component for a predetermined height of the slice. The plurality of successive cross-sectional slices together form the 3D component. The component is then “built-up” slice-by-slice, or layer-by-layer, until finished.

In this manner, the components described herein may be fabricated using the additive process, or more specifically each layer is successively formed, e.g., by fusing or polymerizing a plastic using laser energy or heat or by sintering or melting metal powder. For example, a particular type of additive manufacturing process may use an energy beam, for example, an electron beam or electromagnetic radiation such as a laser beam, to sinter or melt a powder material. Any suitable laser and laser parameters may be used, including considerations with respect to power, laser beam spot size, and scanning velocity. The build material may be formed by any suitable powder or material selected for enhanced strength, durability, and useful life.

Each successive layer may be, for example, between about 10 μm and 200 μm, although the thickness may be selected based on any number of parameters and may be any suitable size according to alternative embodiments. Therefore, utilizing the additive formation methods described above, the components described herein may have cross sections as thin as one thickness of an associated powder layer, e.g., 10 μm, utilized during the additive formation process.

In addition, utilizing an additive process, the surface finish and features of the components may vary as need depending on the application. For example, the surface finish may be adjusted (e.g., made smoother or rougher) by selecting appropriate laser scan parameters (e.g., laser power, scan speed, laser focal spot size, etc.) during the additive process, especially in the periphery of a cross-sectional layer which corresponds to the part surface. For example, a rougher finish may be achieved by increasing laser scan speed or decreasing the size of the melt pool formed, and a smoother finish may be achieved by decreasing laser scan speed or increasing the size of the melt pool formed. The scanning pattern and/or laser power can also be changed to change the surface finish in a selected area.

Notably, in exemplary embodiments, several features of the components described herein were previously not possible due to manufacturing restraints. However, the present inventors have advantageously utilized current advances in additive manufacturing techniques to develop exemplary embodiments of such components generally in accordance with the present disclosure. While the present disclosure is not limited to the use of additive manufacturing to form these components generally, additive manufacturing does provide a variety of manufacturing advantages, including ease of manufacturing, reduced cost, greater accuracy, etc.

In this regard, utilizing additive manufacturing methods, even multi-part components may be formed as a single piece of continuous material, and may thus include fewer sub-components and/or joints compared to prior designs. The integral formation of these multi-part components through additive manufacturing may advantageously improve the overall assembly process. For example, the integral formation reduces the number of separate parts that must be assembled, thus reducing associated time and overall assembly costs. Additionally, existing issues with, for example, leakage, joint quality between separate parts, and overall performance may advantageously be reduced.

Also, the additive manufacturing methods described above enable much more complex and intricate shapes and contours of the components described herein. For example, such components may include thin additively manufactured layers and unique features or geometries. In addition, the additive manufacturing process enables the manufacture of a single component having different materials such that different portions of the component may exhibit different performance characteristics. The successive, additive nature of the manufacturing process enables the construction of these novel features. As a result, the components described herein may exhibit improved performance and reliability.

Now that the construction and configuration of dishwasher appliance 100 and wash pump impeller 182 have been described according to exemplary embodiments of the present subject matter, an exemplary method 300 for manufacturing a wash pump impeller for a dishwasher will be described according to an exemplary embodiment of the present subject matter. Method 300 can be used to additively manufacture wash pump impeller 182 of dishwasher appliance 100, or any other suitable impeller. It should be appreciated that the exemplary method 300 is discussed herein only to describe exemplary aspects of the present subject matter, and is not intended to be limiting.

Referring now to FIG. 10, method 300 includes, at step 310, establishing three-dimensional information of a wash pump impeller. As an example, a model may be designed using a computer and computational fluid dynamics (CFD) software or a prototype may be scanned to determine the three-dimensional information of the impeller. At step 320, the three-dimensional information or model is converted into a plurality of slices, each slice of the plurality of slices defining a respective cross-sectional layer of the wash pump impeller. For example, the wash pump impeller may be modeled in the form of successive slices of wash pump impeller taken along the axial direction.

Step 330 includes fabricating the wash pump impeller using an additive manufacturing process. In this regard, step 330 includes successively forming each cross-sectional layer of the wash pump impeller with an additive manufacturing process, e.g., by repeatedly depositing layers of additive powder and selectively fusing those layers as desired to form the wash pump impeller having the desired geometry or three-dimensional shape defined by the model. The wash pump impeller may be formed using any suitable additive manufacturing process, examples of which are provided above.

FIG. 10 depicts an exemplary method having steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of the methods are explained using dishwasher appliance 100 and wash pump impeller 182 as an example, it should be appreciated that these methods may be applied to any other manufacturing process for forming an impeller.

The wash pump impeller described above achieves a very high a level of hydraulic efficiency, particularly relative to conventional wash pump impellers. In this manner, the wash pump impeller may be smaller and use a smaller motor while achieving the same pump performance, e.g., in terms of pressure head and flow rates achieved. Moreover, the resulting wash pump assembly and dishwasher appliance are quieter, more energy efficient, and more economical to produce (e.g., due in part to less acoustical insulation). These wash pump impellers may further be designed to meet the needs of any specific application to achieve significant hydraulic efficiency improvements, e.g., 5% to 20% improvements in hydraulic efficiency.

Ideally the wash pump impeller construction chosen for a particular pump is largely based on a combination of: the rotational speed, flow rate, and total pressure head (i.e., the sum of the dynamic and static heads) of the wash pump assembly. According to exemplary embodiment, the most efficient impeller for a dishwasher appliance is referred to as a “mixed flow” impeller, which typically has a complex three-dimensional vane shape that is difficult if not impossible to produce by injection molding or must include so few vanes (to avoid manufacturing problems) that the efficiency gains from having optimally formed vanes is lost. However, additive manufacturing permits designing an optimized impeller geometry, establishing three-dimensional information defining that geometry (in the form of a solid model for instance), converting the three-dimensional information into a plurality of slices and then finally successively forming each cross-sectional layer of the mixed-flow impeller with three-dimensional vanes.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A dishwasher appliance comprising:
a wash tub defining a wash chamber for receipt of articles for washing;
a sump for collecting wash fluid;
a wash pump impeller in fluid communication with the wash fluid in the sump and being configured for urging a flow of wash fluid into the wash chamber for cleaning articles, the wash pump impeller comprising:
a hub defining a flow surface, an axial direction, a radial direction, and a circumferential direction;
a plurality of vanes integrally formed with the hub, the vanes extending from the hub at an extension angle relative to the flow surface of the hub, the extension angle being less than 60 degrees.

2. The dishwasher appliance of claim 1, where the extension angle is less than 45 degrees.

3. The dishwasher appliance of claim 1, wherein each of the plurality of vanes defines a leading edge and a trailing edge, wherein the extension angle is larger proximate the trailing edge.

4. The dishwasher appliance of claim 1, wherein the vanes are curved within a radial plane defined perpendicular to the axial direction.

5. The dishwasher appliance of claim 1, wherein the hub defines a hub projection area within a radial plane defined perpendicular to the axial direction, and wherein the vanes define a vane projection area within the radial plane, wherein the vane projection area covers greater than 30% of the hub projection area.

6. The dishwasher appliance of claim 5, wherein the vane projection area is greater than 50% of the hub projection area.

7. The dishwasher appliance of claim 1, wherein the flow surface defines at least one convex portion, at least one concave portion, and at least one straight portion.

8. The dishwasher appliance of claim 1, wherein the hub defines a hub diameter that is less than five inches.

9. The dishwasher appliance of claim 1, wherein the plurality of vanes comprise seven vanes.

10. The dishwasher appliance of claim 1, wherein the plurality of vanes and the hub are additively manufactured as a single monolithic component.

11. The dishwasher appliance of claim 10, wherein the additive manufacturing process comprises at least one of fused deposition modeling, selective laser sintering, stereolithography, and digital light processing.

12. The dishwasher appliance of claim 1, wherein the wash pump impeller comprises a plurality of layers formed by:
depositing a layer of additive material on a bed of an additive manufacturing machine; and
selectively directing energy from an energy source onto the layer of additive material to fuse a portion of the additive material.

13. A method for forming a wash pump impeller for a dishwasher appliance, the method comprising:
establishing three-dimensional information of the wash pump impeller;
converting the three-dimensional information of the wash pump impeller into a plurality of slices, each slice of the plurality of slices defining a respective cross-sectional layer of the wash pump impeller; and
successively forming each cross-sectional layer of the wash pump impeller with an additive manufacturing process.

14. The method of claim 13, wherein the wash pump impeller comprises:
a hub defining a flow surface, an axial direction, a radial direction, and a circumferential direction;
a plurality of vanes integrally formed with the hub, the vanes extending from the hub at an extension angle relative to the flow surface of the hub, the extension angle being less than 60 degrees.

15. The method of claim 14, wherein each of the plurality of vanes defines a leading edge and a trailing edge, wherein the extension angle is larger proximate the trailing edge.

16. The method of claim 14, wherein the hub defines a hub projection area within a radial plane defined perpendicular to the axial direction, and wherein the vanes define a vane projection area within the radial plane, wherein the vane projection area covers greater than 30% of the hub projection area.

17. The method of claim 14, wherein the hub defines a hub diameter that is less than five inches and the plurality of vanes comprise seven vanes.

18. The method of claim 13, wherein the additive manufacturing process comprises at least one of fused deposition modeling, selective laser sintering, stereolithography, and digital light processing.

19. The method of claim 13, wherein the wash pump impeller is a single monolithic component after said step of successively forming.

20. The method of claim 13, wherein the wash pump impeller is formed from a plastic material.
